(19) United States
(12) Patent Application Publication
(10) Pub. No.: US 2025/0191029 A1
(43) Pub. Date: Jun. 12, 2025

(54) INFORMATION PROCESSING APPARATUS

(71) Applicant: TOYOTA JIDOSHA KABUSHIKI KAISHA, Toyota-shi (JP)

(72) Inventor: Kiyotaka MORIIZUMI, Nisshin-shi (JP)

(73) Assignee: TOYOTA JIDOSHA KABUSHIKI KAISHA, Toyota-shi (JP)

(21) Appl. No.: 18/946,923

(22) Filed: Nov. 14, 2024

(30) Foreign Application Priority Data
Dec. 7, 2023 (JP) 2023-207247

(51) Int. Cl. G06Q 30/0251; G05D 1/69; G05D 105/70; G05D 109/10; G06Q 30/0272; G09F 21/04

(52) U.S. Cl. CPC G06Q 30/0266; G05D 1/69; G06Q 30/0272; G09F 21/048; G05D 2105/70; G05D 2109/10

(57) ABSTRACT

An information processing apparatus includes a communication interface, and a controller configured to communicate, using the communication interface, with a plurality of vehicles having displays for displaying images toward outside, and control the plurality of vehicles to display portions of a content image according to respective positions of the plurality of vehicles, when a time period during which an inter-vehicle distance between the plurality of vehicles while traveling is equal to or less than a reference distance has continued for not less than a reference time period.

### CROSS-REFERENCE TO RELATED APPLICATION

This application claims priority to Japanese Patent Application No. 2023-207247, filed on Dec. 7, 2023, the entire contents of which are incorporated herein by reference.

### TECHNICAL FIELD

The present disclosure relates to an information processing apparatus.

### BACKGROUND

Vehicles displaying images such as advertisements on the exterior walls of the vehicle bodies are known. For example, Patent Literature (PTL) 1 discloses a technology for calculating the amount of time that occupants of other vehicles can see a video displayed on a display attached to a vehicle and displaying on the display an advertisement that has been edited so that the video duration corresponds to the amount of time that it can be seen.

### CITATION LIST

### Patent Literature

PTL 1: JP 2020-147107 A

### SUMMARY

There is room for improvement in the visual effect of the content image displayed by the vehicle.

The present disclosure provides an information processing apparatus or the like that enables improvement in the visual effect of the content images displayed by vehicles.

An information processing apparatus in the present disclosure includes:
a communication interface; and
a controller configured to:
   communicate, using the communication interface, with a plurality of vehicles having displays for displaying images toward outside; and
   control the plurality of vehicles to display portions of a content image according to respective positions of the plurality of vehicles, when a time period during which an inter-vehicle distance between the plurality of vehicles while traveling is equal to or less than a reference distance has continued for not less than a reference time period.

According to the information processing apparatus or the like in the present disclosure, it is possible to improve the visual effect of the content images displayed by vehicles.

### BRIEF DESCRIPTION OF THE DRAWINGS

In the accompanying drawings:

FIG. 1 is a diagram illustrating an example configuration of a vehicle management system;

FIG. 2 is a sequence diagram illustrating an operation example of the vehicle management system;

FIG. 3 is a flowchart illustrating an operation example of a server apparatus;

FIG. 4A is a diagram illustrating an example of content image allocation;

FIG. 4B is a diagram illustrating an example of content image allocation;

FIG. 4C is a diagram illustrating an example of content image allocation;

FIG. 5A is a diagram illustrating an example of content image allocation; and

FIG. 5B is a diagram illustrating an example of content image allocation.

### DETAILED DESCRIPTION

Embodiments are described below.

### Configuration of Vehicle Management System

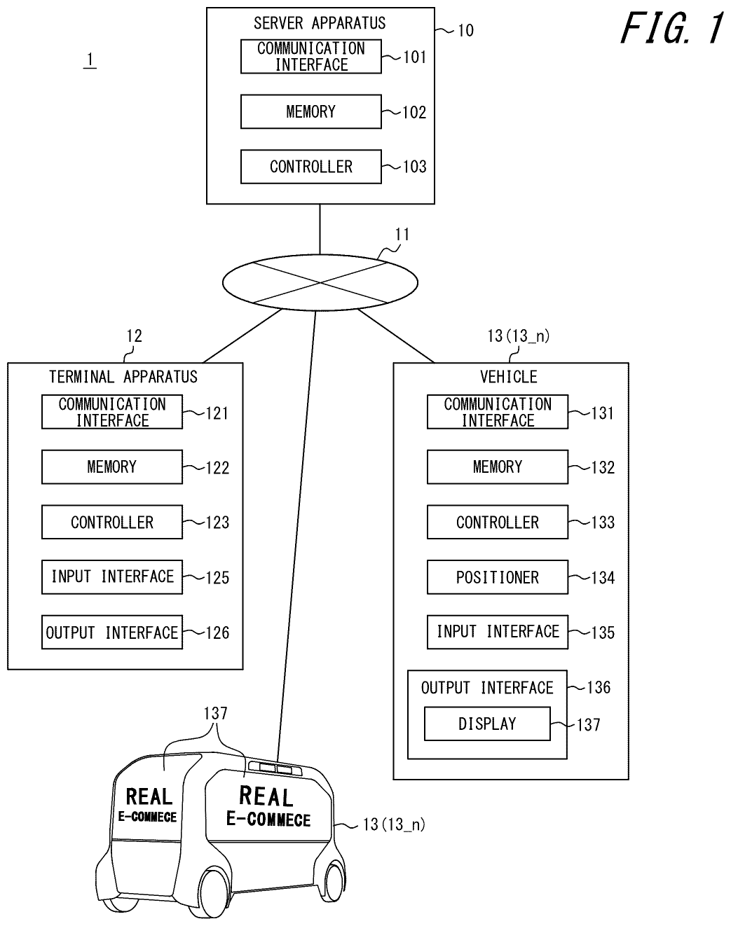

FIG. 1 is a diagram illustrating an example configuration of a vehicle management system 1 according to an embodiment. The vehicle management system 1 includes one or more server apparatuses 10, one or more terminal apparatuses 12, and a plurality of vehicles 13, which are communicably connected to each other via a network 11. The server apparatus 10 is, for example, a server computer that belongs to a cloud computing system or other computing system and functions as a server that implements various functions. The server apparatus 10 corresponds to an “information processing apparatus” in the present embodiment. The terminal apparatus 12 is an information processing terminal used by operators of businesses that place advertisements on the vehicles 13, and exchanges various information with the server apparatus 10. The terminal apparatus 12 is, for example, a personal computer. The vehicle 13 has a display 137 for displaying advertisements and other content images on the exterior walls of the vehicle body. The vehicle 13 is a commercial vehicle, such as a bus or a truck, for example, but may be a passenger car. The vehicle 13 is provided with communication functions and information processing functions and is connected to the network 11 via a mobile communication network. The vehicle 13 may be driven by a driver, or driving may be automated at any level, such as one of Level 1 to Level 5 defined by the Society of Automotive Engineers (SAE). The vehicle 13 is a battery electric vehicle (BEV) or a hybrid electric vehicle (HEV) that uses battery power for at least part of the energy for driving. In the following, when multiple vehicles 13 are distinguished from each other, they will be numbered as vehicle 13-n (n=1, 2, . . . ) with the branch number. The network 11 may, for example, be the Internet or may include an ad hoc network, a local area network (LAN), a metropolitan area network (MAN), other networks, or any combination thereof.

In the present embodiment, the vehicle management system 1 controls the display of content images by a plurality of vehicles 13. The server apparatus 10 includes a communication interface 101 and a controller 103 that communicates via the communication interface 101. The controller 103 communicates, using the communication interface 101, with a plurality of vehicles 13 having displays 137 for displaying images toward outside, and controls the plurality of vehicles 13 to display portions of a content image according to the respective positions of the plurality of vehicles 13, when a time period during which an inter-vehicle distance between the plurality of vehicles 13 while traveling is equal to or less than a reference distance has continued for not less than a reference time period. Since content images can be displayed using a large display surface formed by combining the display surfaces of the displays 137 of the plurality of vehicles 13 (hereinafter referred to as the combined display surface), it is possible to improve the visual effect of content images.

### Configuration of Server Apparatus 10

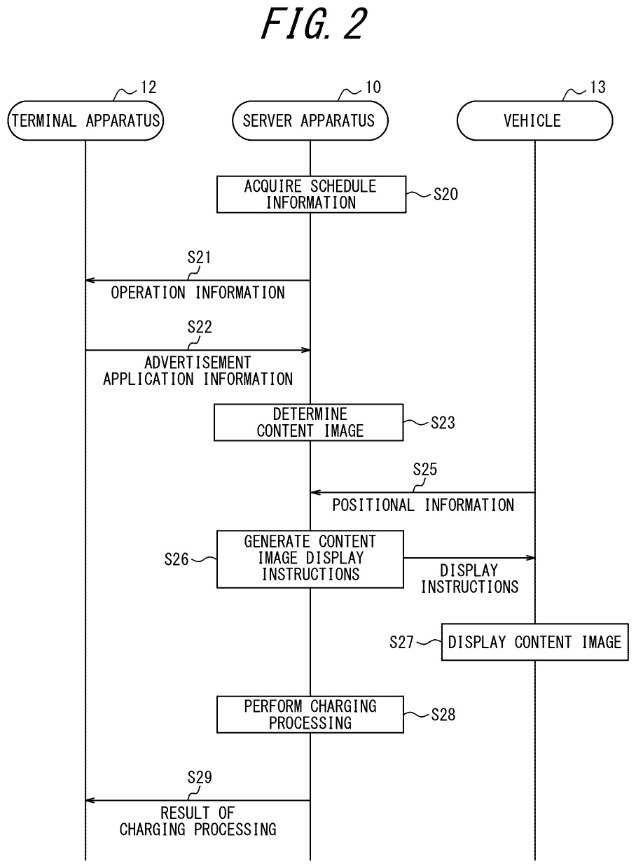

The server apparatus 10 includes the communication interface 101, a memory 102, and the controller 103. The server apparatus 10 is, for example, a single computer. The server apparatus 10 may be two or more computers that are communicably connected to each other and operate in cooperation. In this case, the configuration illustrated in FIG. 2 can be arranged among two or more computers as appropriate.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the vehicles 13 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The functions of the server apparatus 10 are realized by a processor included in the controller 103 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

### Configuration of Terminal Apparatus 12

The terminal apparatus 12 includes a communication interface 121, a memory 122, the controller 123, an input interface 125, and an output interface 126.

The communication interface 121 includes a communication module compliant with a wired or wireless LAN standard, a module compliant with a mobile communication standard such as Long Term Evolution (LTE), 4th Generation (4G), or 5th Generation (5G), or the like. The terminal apparatus 12 connects to the network 11 via a nearby router apparatus or mobile communication base station using the communication interface 121 and communicates information with other apparatuses over the network 11.

The memory 122 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 122 functions as, for example, a main memory, an auxiliary memory, or a cache memory. The memory 122 stores information to be used for the operations of the controller 123 and information obtained by the operations of the controller 123.

The controller 123 has one or more general purpose processors such as CPUs or micro processing units (MPUs) or one or more dedicated processors that are dedicated to specific processing. Alternatively, the controller 123 may have one or more dedicated circuits such as FPGAs or ASICs. The controller 123 is configured to perform overall control of the operations of the terminal apparatus 12 by operating according to the control/processing programs or operating according to operating procedures implemented in the form of circuits. The controller 123 then transmits and receives various types of information to and from the server apparatus 10 and the like via the communication interface 121 and executes the operations according to the present embodiment.

The input interface 125 includes one or more interfaces for input. The interface for input includes, for example, a physical key, a capacitive key, a pointing device, a touch screen integrally provided with the display, a camera that captures images or image codes, or an IC card reader. The interface for input may include a microphone that accepts audio input. The input interface 125 accepts input of information to be used in the operations of the controller 123 and transmits the inputted information to the controller 123.

The output interface 126 includes one or more interfaces for output. The interface for output is, for example, a display or a speaker. The display is, for example, a Liquid Crystal Display (LCD) or an organic Electro Luminescent (EL) display. The output interface 126 outputs information obtained by the operations of the controller 123.

The functions of the controller 123 are realized by a processor included in the controller 123 executing a control program. The control program is a program for causing the processor to function as the controller 123. Some or all of the functions of the controller 123 may be realized by a dedicated circuit included in the controller 123.

### Example Configuration of Vehicle 13

The vehicle 13 includes a communication interface 131, a memory 132, a controller 133, a positioner 134, an input interface 135, and an output interface 136. The output interface 136 includes a display 137. One or more of these components may be configured as a single control apparatus, or may be configured by a personal computer including a tablet terminal, a smartphone terminal, or a navigation apparatus. Alternatively, each component may be connected via an in-vehicle network compliant with a standard such as controller area network (CAN) to enable communication of information.

The memory 132, the controller 133, and the input interface 135 have configurations equivalent to those of the memory 122, the controller 123, and the input interface 125 of the terminal apparatus 12, respectively.

The communication interface 131 includes one or more interfaces for communication. Examples of the interface for communication include an interface corresponding to mobile communication standards, such as LTE, 4G, or 5G. The communication interface 131 receives information to be used for the operations of the controller 133 and transmits information obtained by the operations of the controller 133. The controller 133 connects to the network 11 using the communication interface 131 through a mobile communication base station and communicates information with other apparatuses via the network 11.

The positioner 134 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. Based on the information acquired by the positioner 134, the positional information for the vehicle 13 is obtained.

The output interface 136 includes one or more output interfaces for outputting information obtained by the operation of the controller 123. The interface for output includes, for example, a display or speaker and further includes a display 137 provided outside the vehicle body. The display is, for example, an LCD or an organic EL display. The display 137 is a rectangular LED (Light Emitting Diode) display, for example, several meters or more on a side.

The controller 133 controls each of the communication interface 131, the memory 132, the positioner 134, the input interface 135, and the output interface 136 while exchanging various information with these components and also controls the operation of the vehicle 13.

### Operations of Vehicle Management System 1

FIG. 2 is a sequence diagram illustrating an example procedure for coordinated operations of the server apparatus 10, the terminal apparatus 12, and the vehicles 13. The steps pertaining to the various information processing by the server apparatus 10, the terminal apparatus 12, and the vehicles 13 in FIG. 2 are performed by the respective controllers 103, 123, 133. The steps pertaining to transmitting and receiving various types of information to and from the server apparatus 10, the terminal apparatus 12, and the vehicles 13 are performed by the respective controllers 103, 123, 133 transmitting and receiving information to and from each other via the respective communication interfaces 101, 121, 131. In the server apparatus 10, the terminal apparatus 12, and the vehicles 13, the respective controllers 103, 123, 133 appropriately store the information that is processed and transmitted and received in the respective memories 102, 122, 132.

In step S20, the server apparatus 10 acquires schedule information for each of the plurality of vehicles 13. The schedule information includes the area and time period that each of the vehicles 13 travels. The schedule information may be stored by each vehicle 13 and transmitted from the vehicle 13 to the server apparatus 10, or the schedule information for each vehicle 13 may be stored in the server apparatus 10 and read by the controller 103. Step S20 is performed once a day, for example.

In step S21, the server apparatus 10 transmits operation information to the terminal apparatus 12. The operation information includes information on advertising rates for each area and time period in which the plurality of vehicles 13 travels. The advertisements are displayed as content images on the combined display surface by the displays 137 of the plurality of vehicles 14. Advertising rates are set to increase with, for example, the size of the combined display surface or the number of vehicles 14 forming the combined display surface. Advertising rates may also be increased or decreased based on area attributes and a time period. For example, it is possible to set higher advertising rates for areas with higher population density, time periods, or combinations of areas and time periods, since it is presumed that more consumers will be exposed to the advertisements.

In step S22, the server apparatus 10 receives advertisement application information from the terminal apparatus 12. The advertisement application information includes identification information identifying the operator and its financial information, information specifying the area and the time period in which the vehicles 13 travel, and data on content images for the advertisement. The terminal apparatus 12 outputs the operation information received from the server apparatus 10 by display, etc., and transmits the advertisement application information to the server apparatus 10 in response to an operation for advertising application by the operator of the business.

In step S23, the server apparatus 10 determines the content image for each set of vehicles 14. The server apparatus 10 corresponds a content image to each set of the plurality of vehicles 14 traveling in the same area and the same time period in response to an advertisement application. If a plurality of content images is applied for one set of vehicles 14, the server apparatus 10 prioritizes the plurality of content images by, for example, the order of application, the order of the advertising fee, etc., and assigns a content image with a higher priority than one or more other content images to the set of vehicles 14. Alternatively, the server apparatus 10 can derive the aspect ratio of the rectangular combined display surface and select content images based on matching the aspect ratio. The aspect ratio is classified, for example, as at least vertical or horizontal. For example, the server apparatus 10 has previously stored in the memory 102 information on the display surface to be generated by the display 137 for each vehicle 14, and such information can be used to derive the aspect ratio of the planned combined display surface.

When the operation of the vehicles 14 starts, in step S25, the server apparatus 10 acquires positional information for each vehicle 14. Each vehicle 14 transmits information on its current position to the server apparatus 10 at an arbitrary cycle, e.g., tens of microseconds to several seconds.

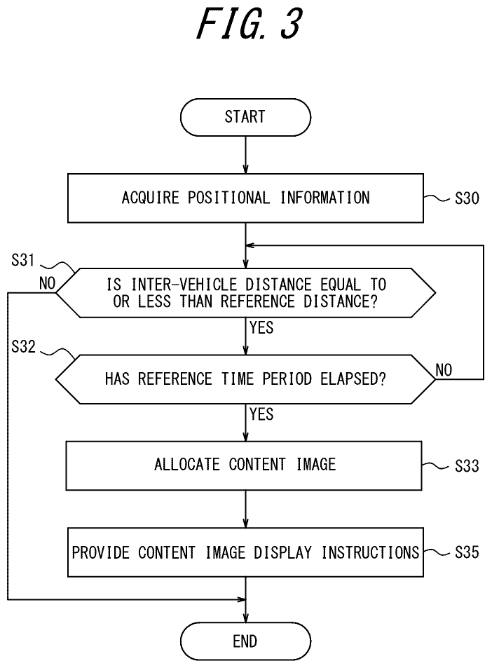

In step S26, the server apparatus 10 generates content image display instructions for each vehicle 14 and transmits the instructions to each vehicle 14. The detailed procedure of step S26 is illustrated in FIG. 3.

FIG. 3 is a flowchart illustrating an example operation procedure for the server apparatus 10 generating content image display instructions. Each step of FIG. 3 is executed by the controller 103.

In step S30, the controller 103 acquires positional information for each vehicle 14 for each set of vehicles 14. The controller 103 reads the positional information transmitted from each of the vehicles 14 and stored in the memory 102.

In step S31, the controller 103 determines whether the inter-vehicle distance between the vehicles 14 is equal to or less than the reference. The controller 103 derives the inter-vehicle distance from the difference in the positions of the vehicles 14 and compares it to the reference. The inter-vehicle distance may be the front/rear distance when the plurality of vehicles 14 travels in parallel, or the left/right distance when a plurality of vehicles 14 travels in parallel. When the plurality of vehicles 14 travels in parallel, the combined display surface is formed by the displays 137 on the sides of each vehicle 14, and when the plurality of vehicles 14 travels in parallel, the combined display surface is formed by the displays 137 on the rear surface of each vehicle 14. The reference is a distance that is large enough to ensure safe driving of the vehicle 14 and small enough to form a coupled display surface by the display surface of the display 137. The controller 103 can use the reference when the positions of the plurality of vehicles 14 are in a vertical line, or when the positions of the plurality of vehicles 14 are in parallel. When the inter-vehicle distance is equal to or less than the reference (Yes in step S31), the controller 103 proceeds to step S32, whereas when the inter-vehicle distance is not equal to or less than the reference (No in step S31), the controller 103 terminates the procedure of FIG. 3.

In step S32, the controller 103 determines whether the reference time period has elapsed with the inter-vehicle distance between the vehicles 14 being equal to or less than the reference. The reference time period is arbitrarily set from ten to several tens of seconds as a sufficient time period to display the content image on the combined display surface. When the reference time period has elapsed (Yes in step S32), the controller 103 proceeds to step S33, whereas when the reference time period has not elapsed (No in step S32), the controller 103 returns to step S31.

In step S33, the controller 103 allocates content images to the display surfaces of the plurality of vehicles 14. The controller 103 allocates a portion of the content image to each vehicle 14 according to the position of each vehicle 14.

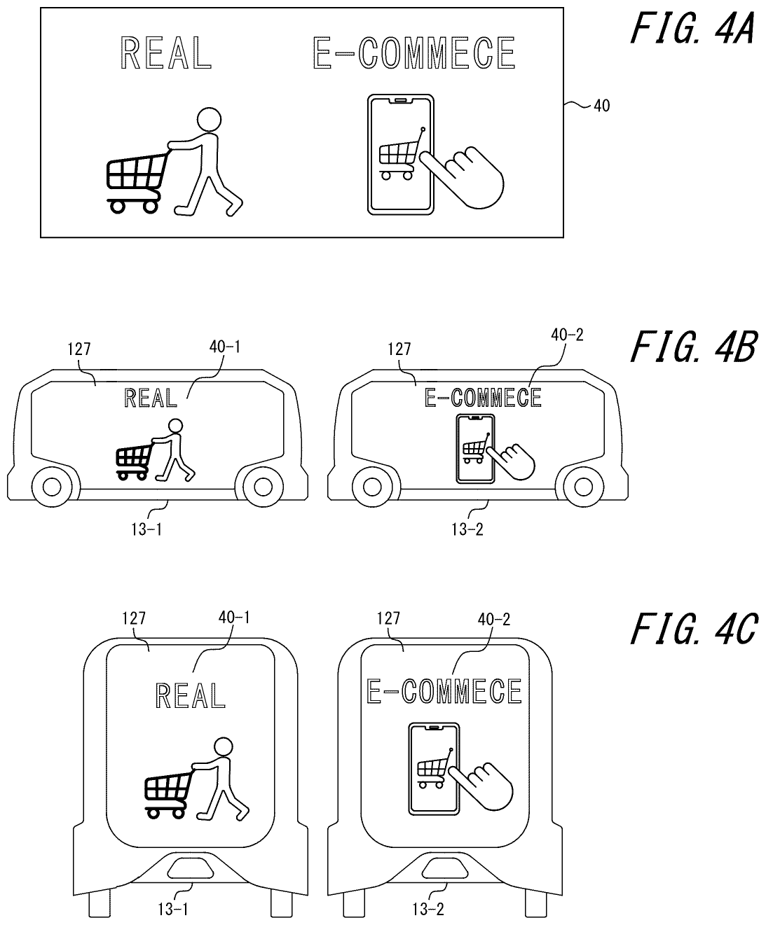

FIGS. 4A to 4C illustrate examples of content image allocation. An example of how the content image 40 illustrated in FIG. 4A is allocated to vehicles 13-1 and 13-2 in a vertical row is illustrated in FIG. 4B, and an example of how it is allocated to vehicles 13-1 and 13-2 in parallel is illustrated in FIG. 4C. When vehicles 13-1 and 13-2 are vertically aligned as illustrated in FIG. 4B, the controller 103 allocates the respective displays 127 to display partial content images 40-1 and 40-2, which are divided into left and right portions of the content image 40, respectively. When vehicles 13-1 and 13-2 are in parallel as illustrated in FIG. 4C, the controller 103 allocates the respective displays 127 to display the partial content images 40-1 and 40-2, which are divided into left and right sides of the content image 40, respectively.

Returning to FIG. 3, in step S35, the controller 103 transmits content image display instructions to each of the plurality of vehicles 14. The display instructions include data for a portion of the assigned content image. The display instructions also include information about the distinction between the display surfaces on which a portion of the content image should be displayed, e.g., the left and right sides and the rear surface. The controller 103 then terminates the procedure of FIG. 3.

Returning to FIG. 2, in step S27, each of the vehicles 13 displays a portion of the content image based on display instructions transmitted by the server apparatus 10, respectively. As illustrated in FIG. 4B or FIG. 4C, when vehicles 13-1 and 13-2 display content images 40-1 and 40-2, respectively, the content image 40 is displayed as a whole on the combined display surface formed by the display 127 of each of vehicles 13-1 and 13-2.

In step S28, the server apparatus 10 performs the charging processing for advertising fees related to the display of content images. The server apparatus 10 executes the charging processing in conjunction with the server that manages the financial account of the business, using the identification information of the business that has applied to place an advertisement.

In step S29, the server apparatus 10 transmits the results of the charging processing to the terminal apparatus 12 and terminates the procedure of FIG. 2.

The operation of each component of the vehicle management system 1 according to the procedure described above enables the enhancement of the visual effect of the content images displayed by the vehicles.

### Variation

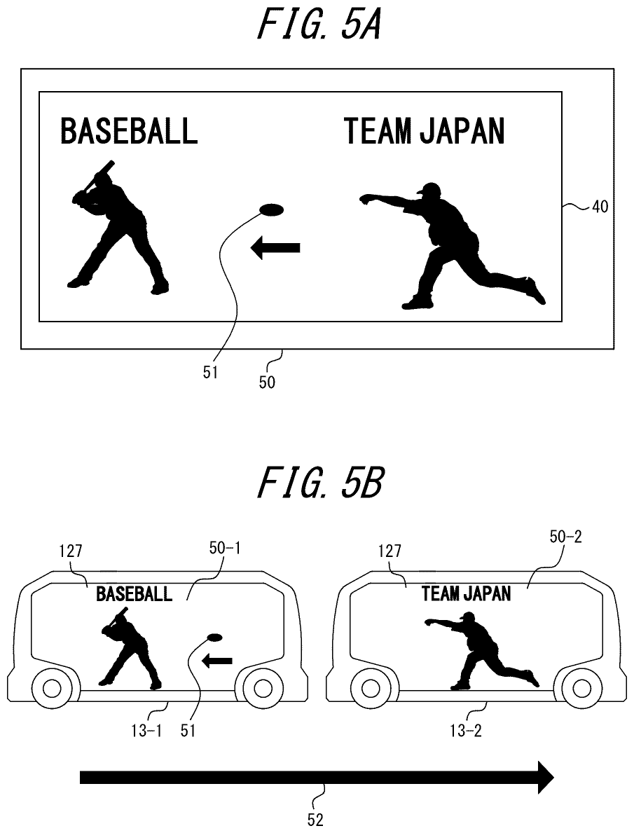

FIG. 5A and FIG. 5B illustrate an example of content image allocation in a variation. The content image 50 illustrated in FIG. 5A is a moving image that includes an object 51 moving from right to left in the drawing. As illustrated in FIG. 5B, when vehicles 13-1 and 13-2 travel in a longitudinal line in accordance with the travel direction 52 indicated by the arrow, the controller 103, for example, displays partial content images 50-1 and 50-2, respectively, which are obtained by dividing the content image 50 into left and right portions, on the respective displays 127. In this case, the content images 50-1 and 50-2 are allocated so that the travel direction 52 of vehicles 13-1 and 13-2 and the travel direction of the object 51 are opposite each other. The travel direction of the object 51 is derived by the controller 103 from the content image 50, and the travel direction of vehicles 13-1 and 13-2 is derived from the change over time of the positions of vehicles 13-1 and 13-2. By doing so, the speed of movement of the object 51 is emphasized when a stationary observer observes the content images 50 as a whole. Alternatively, the travel direction of the object 51 may be the same as the travel direction 52 of vehicles 13-1 and 13-2. By doing so, it is possible to stably observe the movement of the object 51 when the observer is traveling in the same direction as the travel direction 52 of vehicles 13-1 and 13-2.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. An information processing apparatus comprising:
a communication interface; and
a controller configured to:
communicate, using the communication interface, with a plurality of vehicles having displays for displaying images toward outside; and
control the plurality of vehicles to display portions of a content image according to respective positions of the plurality of vehicles, when a time period during which an inter-vehicle distance between the plurality of vehicles while traveling is equal to or less than a reference distance has continued for not less than a reference time period.

2. The information processing apparatus according to claim 1, wherein the controller is configured to select a content image with a higher priority than one or more other content images from among a plurality of content images as a content image to be displayed by the plurality of vehicles.

3. The information processing apparatus according to claim 1, wherein the controller is configured to select a content image corresponding to an aspect ratio of a display surface formed by the displays of the plurality of vehicles from among a plurality of content images as a content image to be displayed by the plurality of vehicles.

4. The information processing apparatus according to claim 1, wherein the controller is configured to select a content image according to a section or a time period in which the plurality of vehicles travels from among a plurality of content images as a content image to be displayed by the plurality of vehicles.

5. The information processing apparatus according to claim 1, wherein the controller is configured to allocate, when the content image, which is to be displayed on the displays at respective sides of the plurality of vehicles, includes a mobile object, the portions of the content image to the plurality of vehicles so that a travel direction of the mobile object is in a predetermined relationship with a travel direction of the plurality of vehicles.
